(19) United States
(12) Patent Application Publication
(10) Pub. No.: US 2015/0284276 A1
(43) Pub. Date: Oct. 8, 2015

(54) METHOD AND DEVICE FOR TREATING FOULING IN WATER SYSTEMS

(71) Applicant: Fredrick Billy Otieno Ongeche, Wichita, KS (US)

(72) Inventor: Fredrick Billy Otieno Ongeche, Wichita, KS (US)

(21) Appl. No.: 14/243,291

(22) Filed: Apr. 2, 2014

(51) Int. Cl. C02F 9/00; C02F 1/46; C02F 1/42

(52) U.S. Cl. CPC C02F 9/00; C02F 1/42; C02F 1/46

(57) ABSTRACT

The present disclosure relates generally to methods, devices and systems that treat multiple modes of fouling throughout water systems. More specifically, the present disclosure comprises an electrochemical reaction tank that treats fouling due to, for example, corrosion, scale formation, microbial growth and/or particulate build-up in water.

### FIELD OF THE DISCLOSURE

The present disclosure relates generally to methods, devices and systems that treat multiple modes of fouling throughout water systems. More specifically, the present disclosure comprises an electrochemical reaction tank that treats fouling due to, for example, corrosion, scale formation, microbial growth and/or particulate build-up in water.

### BACKGROUND OF THE DISCLOSURE

Fouling of water is prevalent in many types of water conducting systems, such as, for example, cooling towers, boilers, condensers, chilled and emergency eye wash and safety shower water circuits. The water fouling can take on several forms, including fouling due to scale formation, corrosion, microbial growth and particulate build-up in the water. Such water fouling leads to loss of heat transfer efficiency in the systems, excessive use of water, equipment degradation and the spread of waterborne diseases.

Notably, multiple types of water fouling are interrelated—one mode of fouling often promotes and exacerbates the others. For example, scaling can increase the amount of suspended solids, which shields and protects waterborne microbes from disinfectants. Additionally, under deposit corrosion of metallic surfaces can occur when suspended solids settle in low flow areas, which corrosion in turn increases the amount of suspended solids, providing nutrients and shelter to waterborne microbes and thus promoting microbial fouling.

Previous attempts to treat water fouling focus on only one of the modes of fouling, treatments of which can exacerbate the other types of fouling. There are many disadvantages that result from the current attempts to treat water fouling, including, but not limited to: higher operations costs due to increased energy, pumping and filtration requirements; excessive loss of water from continuous purging; lack of flexibility to allow the water treatment process to react to dynamic changes in water systems due to process leaks, change in load, make-up water quality or introduction of environmental contaminants due to rain or dust; and, inability to provide a long lasting residual disinfectant for effectively suppressing the proliferation of microbial contaminants within the entire water system.

There remains a need, therefore, for a process, system, means and device that is compact, simple, environmentally friendly, safe and convenient to use that controls all modes of water fouling throughout a water system.

### SUMMARY OF THE DISCLOSURE

Briefly, therefore, the present disclosure is directed to a process for treating fouling in water systems, the process comprising: delivering water to a cooling tower for cooling the water; delivering some of the water from the cooling tower to an electrochemical cell reaction tank, to define a flow of treated water, the reaction tank comprising at least one anode and at least one cathode; supplying current to the reaction tank from a controller power supply; delivering the treated water to a basin; delivering the remaining water from the cooling tower toward a condenser to define a flow of carrier water; delivering the carrier water from the condenser into the cooling tower and toward the basin; and combining the flow of treated water with the flow of carrier water in the basin.

The present disclosure is also directed to a system for treating fouling in water, the system comprising: water; a cooling tower for cooling the water; a basin for collecting the cooled water; an electrochemical cell reaction tank, the reaction tank comprising at least one anode and at least one cathode, the at least one anode and the at least one cathode being connected to a source of power; a condenser for heating the water; and, a delivery system operable to deliver some of the water from the basin to the electrochemical cell reaction tank to produce a flow of treated water, and delivering the treated water to the basin, the delivery system being further operable to deliver the remaining water from the basin through the condenser, into the cooling tower, and then back into the basin for admixture with the treated water to define a combined flow of water.

The present disclosure is also directed to an electrochemical reaction tank device for treating fouling in water systems. The device comprises: a tank container comprising at least one water inlet and at least one water outlet; a first metallic fin array comprising at least one non-sacrificial anode; a second metallic fin array comprising at least one cathode; wherein the first fin array and the second fin array are arranged circumferentially within the tank; and, a device for connecting the at least one sacrificial anode to a power source.

Other objects and features will be in part apparent and in part pointed out hereinafter.

### BRIEF DESCRIPTION OF THE DRAWINGS

FIG. 1 is a schematic diagram of an exemplary embodiment of a cooling tower water treatment system in accordance with the present disclosure.

FIG. 2 is a schematic diagram of another exemplary embodiment of a cooling tower water treatment system in accordance with the present disclosure.

FIG. 3 is a schematic diagram of yet another exemplary embodiment of a cooling tower water treatment system in accordance with the present disclosure.

FIG. 4 is a schematic diagram of yet another exemplary embodiment of a cooling tower water treatment system in accordance with the present disclosure.

FIG. 5 is a cross-sectional view of an exemplary embodiment of an electrochemical cell reaction tank in accordance with the present disclosure.

FIG. 6 is a sectional through view of an exemplary embodiment of an electrochemical cell reaction tank in accordance with the present disclosure.

FIG. 7 is a sectional view of an exemplary embodiment of a cathode assembly within a reaction tank in accordance with the present disclosure.

FIG. 8 is a cross-sectional view of an exemplary embodiment of a cathode plate and electrode assembly mounting tab in accordance with the present disclosure.

FIG. 9 is a cross-sectional view of an exemplary embodiment of a non-sacrificial anode in accordance with the present disclosure.

FIG. 10 is a cross-sectional view of an exemplary embodiment of an assembly rod in accordance with the present disclosure.

FIG. 11 is a top view of an exemplary embodiment of an insulator disk in accordance with the present disclosure.

FIG. 12 is a cross-sectional view of an exemplary embodiment of an insulator disk in accordance with the present disclosure.

FIG. 13 is a cross-sectional view of an exemplary embodiment of a sacrificial anode in accordance with the present disclosure.

### DETAILED DESCRIPTION OF THE DISCLOSURE

The present disclosure is directed to providing processes, systems, means and devices for treating water fouling. The present disclosure is not only suitable for use against a single type of fouling, but also can be utilized to treat multiple types of fouling.

### Systems and Processes for Treating Fouling in Water

The present disclosure is directed to a process for treating fouling in water systems. The process comprises delivering water to a cooling tower for cooling the water; delivering some of the water from the cooling tower to an electrochemical cell reaction tank, to define a flow of treated water, the reaction tank comprising at least one anode and at least one cathode; supplying current to the reaction tank from a controller power supply; delivering the treated water to a basin; delivering the remaining water from the cooling tower toward a condenser to define a flow of carrier water; delivering the carrier water from the condenser into the cooling tower and toward the basin; and combining the flow of treated water with the flow of carrier water in the basin.

The present disclosure is also directed to a system for treating fouling in water. The system comprises: water; a cooling tower for cooling the water; a basin for collecting the cooled water; an electrochemical cell reaction tank, the reaction tank comprising at least one anode and at least one cathode, the at least one anode and the at least one cathode being connected to a source of power; a condenser for heating the water; and, a delivery system operable to deliver some of the water from the basin to the electrochemical cell reaction tank to produce a flow of treated water, and delivering the treated water to the basin, the delivery system being further operable to deliver the remaining water from the basin through the condenser, into the cooling tower, and then back into the basin for admixture with the treated water to define a combined flow of water.

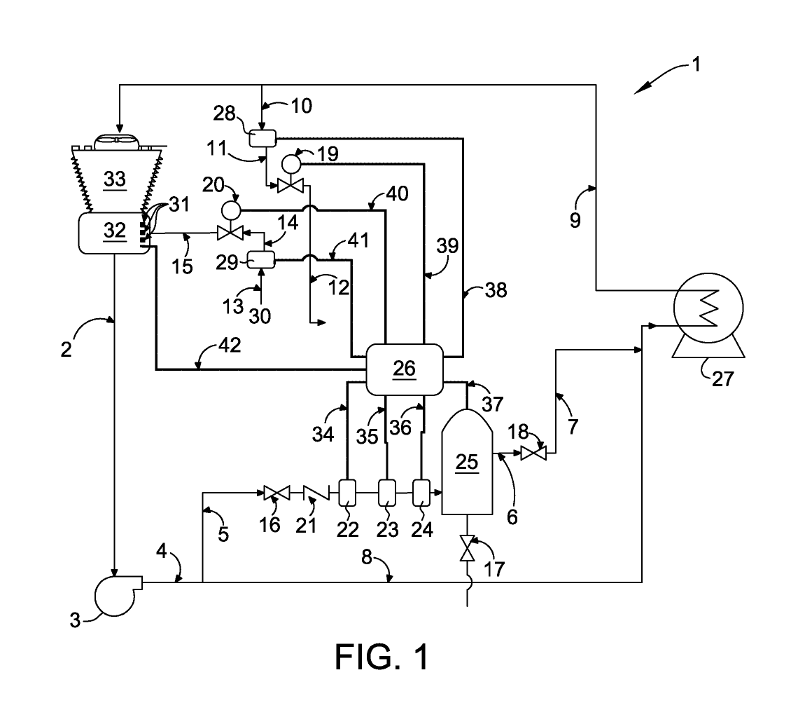

Referring now to FIG. 1, an exemplary water system 1 in accordance with the present disclosure is shown. In the treatment, warm water from condenser 27 flows through a pipe 9 and is delivered into the top of the cooling tower 33. As the water trickles down the cooling tower 33, air is pulled through the tower 33 by a fan (not shown) causing evaporation of a portion of the water. The remaining water now cooled by the cooling tower 33 and with a slightly higher concentration of dissolved minerals is collected in the cooling tower basin 32.

This cooled water then flows through a pipe 2 and is pressurized by a pump 3 as the water flows through a pipe 4 and through a pipe 8 and then into the condenser 27 where the water is heated and expelled through a pipe 9 and then is delivered back into the cooling tower 33. This cycle can be repeated numerous times.

Continuous circulation can cause the cooling water to become concentrated with dissolved and suspended solids such as minerals, waterborne microbes, mold, algae, dust dirt and sand among others. If left unchecked, such conditions could lead to proliferation of harmful pathogens such as Legionella bacteria, corrosion, scale and biofilm formation on heat transfer surfaces, which can lead to efficiency loss and costly operation of the cooling system.

In some embodiments, to keep the cooling system operational, concentrated water can be released (blow down) from the cooling system and fresh water (make-up) can be added to replace water loss via purging and evaporation. Frequent or continuous purging is disadvantageous, however, since it leads to higher water use and increased operations costs.

Turning back to FIG. 1, in some embodiments of the present disclosure, some of the water from the cooling tower 33 can be delivered to an electrochemical cell reaction tank 25 to define a flow of treated water. The reaction tank 25 can comprise at least one anode and at least one cathode. In some embodiments of the present disclosure, prior to reaching the reaction tank 25, some of the water of the cooling tower is delivered through a pipe 5 and then through a reaction tank inlet valve 16, a check valve 21, and then a series of sensors, including a disinfectant sensor 22, a flow detecting sensor 23 and a conductivity sensor 24.

After passing through these respective valves (16, 21) and sensors (22, 23 and 24), some of the water from the cooling tower then enters the reaction tank 25. Once in the reaction tank 25, current is supplied to reaction tank 25 from a controller power supply 26 to treat the water. After the water is treated in the reaction tank 25, the water then exits the reaction tank through a pipe 6 and can travel through a reaction tank outlet valve 18 through a pipe 7 and toward the condenser 27. In some embodiments, some of the water in the reaction tank 25 can be drained via a drain valve 17.

In some embodiments, the treated water is delivered to the condenser 27 from the reaction tank 25. Additionally, the remaining water from the cooling tower 33 that did not enter the reaction tank 25 is also delivered toward the condenser 27 via a piping system including pipes 2, 4 and 8 and a pump 3 and defines a flow of carrier water. The treated water and the carrier water can combine one of upstream of the condenser 27 and at the condenser 27 to define a combined flow of water. At that point, the combined flow of water can be delivered back to the cooling tower 33. Advantageously, when the treated water is combined with the carrier water from the cooling tower 33, all modes of water fouling are affected throughout the entire water system 1.

In some embodiments, some of the combined water can be purged through a pipe 10, into a water sensor 28, through a pipe 11, through a bleed valve 19 and exit the water system 1 through a pipe 12.

In some embodiments, a source of make-up water 30 is admitted into the water system through a pipe 13 and into a water meter sensor 29, through a pipe 14, through a make-up water valve 20 traveling through a pipe 15 and into the basin 32. In some embodiments, the basin 32 includes at least one water level sensor 31. In other embodiments, the basin 32 includes multiple water level sensors 31. The water level sensor 31 can detect the amount of water in the basin 32.

In some embodiments of the present disclosure, the water system 1 includes electrical wiring. The electrical wiring connects various components of the water system 1 to the power supply 26. In some embodiments, the disinfectant sensor 22 is connected to the power supply 26 by an electrical line 34. In some embodiments, the flow detecting sensor 23 is connected to the power supply 26 by an electrical line 35. In some embodiments, the conductivity sensor 24 is connected to the power supply 26 by an electrical line 36. In some embodiments, the reaction tank 25 is connected to the power supply 26 by an electrical line 37. In some embodiments, the water sensor 28 is connected to the power supply 26 by an electrical line 38. In some embodiments, the bleed valve 19 is connected to the power supply 26 by an electrical line 39. In some embodiments, the make-up water valve 20 is connected to the power supply 26 by an electrical line 40. In some embodiments, the water meter 29 is connected to the power supply by an electrical line 41. In some embodiments, the water level sensor 31 in the basin 32 is connected to the power supply 26 by an electrical line 42.

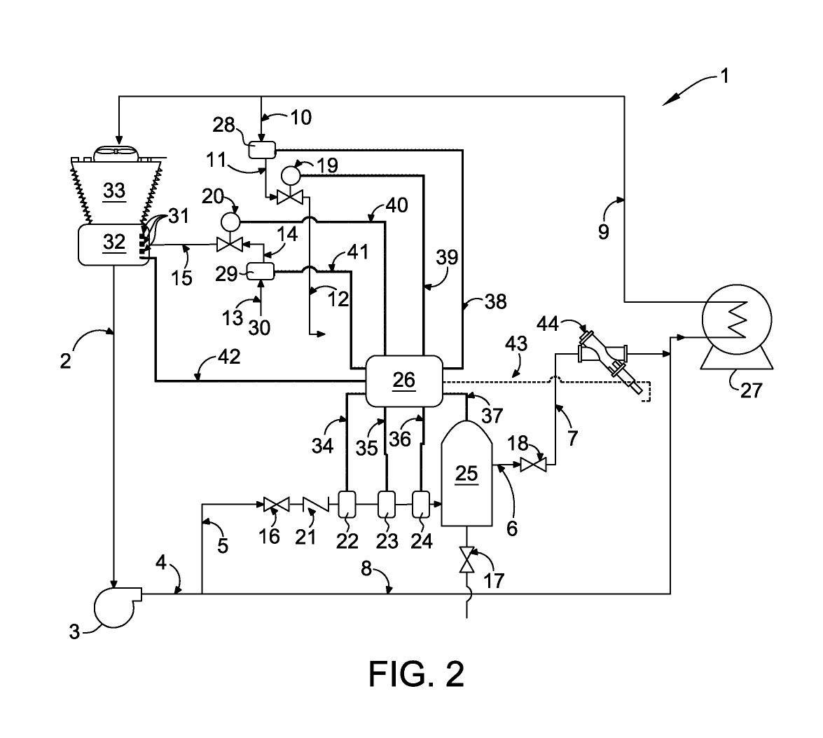

Referring now to FIG. 2, in alternative embodiments of the present disclosure, a particulate filter may be included in the water system 1. In some embodiments, the particulate filter 44 can be connected to the power supply 26 by an electrical line 43. In some embodiments, the particulate filter 44 can be located intermediate the reaction tank 25 and the condenser 27.

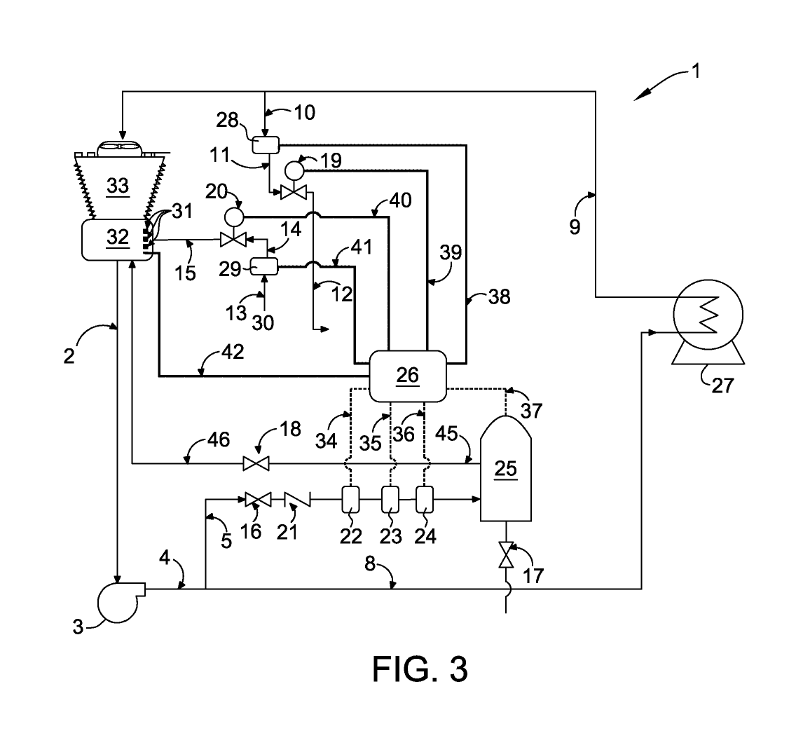

Referring now to FIG. 3, in alternative embodiments of the present disclosure, some of the water from the cooling tower 33 is delivered to the reaction tank 25 and then to the basin 32 from the reaction tank 25 instead of from the reaction tank 25 to the condenser 27. In some embodiments, the treated water from the reaction tank 25 exits the reaction tank 25 through a pipe 45, through the reaction tank outlet valve 18, through a pipe 46 and then into the basin 32. In such embodiments, the treated water does not combine with the carrier water as described in FIGS. 1 and 2, but, instead, is delivered back into the basin 32 after treatment in the reaction tank 25 and then combines with the carrier water in the basin to form a flow of combined water.

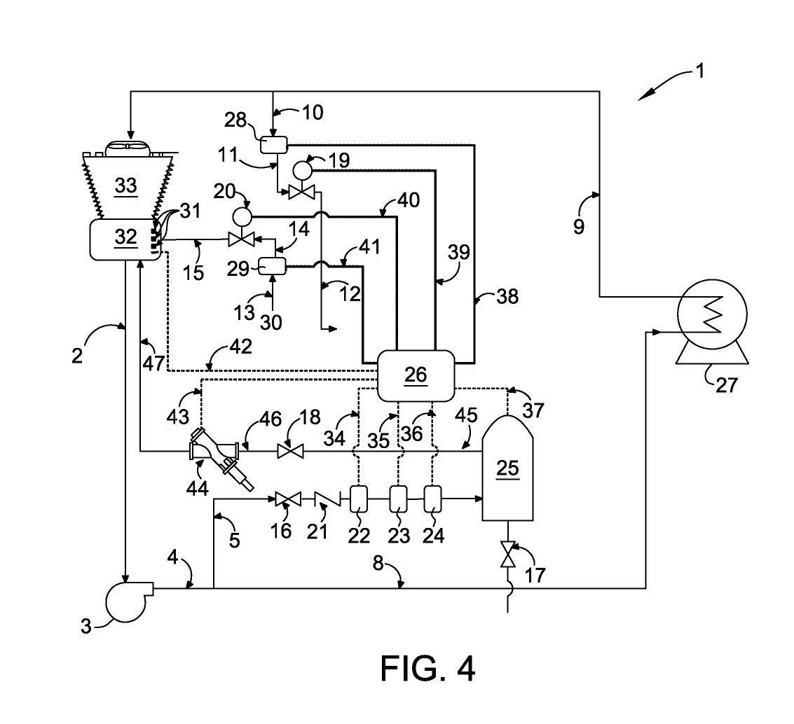

Referring now to FIG. 4, in alternative embodiments of the present disclosure, a particulate filter 44 may be included in the water system 1. In some embodiments, the particulate filter 44 can be connected to the power supply 26 by an electrical line 43. In some embodiments, the particulate filter 44 can be located intermediate the reaction tank 25 and the basin 32. In some embodiments, water that is treated in the reaction tank 25 exits the tank 25 through a pipe 45, through the reaction tank outlet valve 18, through a pipe 46, through particulate filter 44, through a pipe 47 and then into the basin 32.

There are several types of water defined in systems and processes of the present disclosure. Generally, the water from the cooling tower 33 will circulate through basin 32, pipe 2, pump 3, pipe 4, pipe 8, condenser 27, pipe 9 and then back into the cooling tower 33. This process can repeat numerous times and defines recirculating water.

In accordance with the present disclosure, some of this recirculated water can be portioned off and travel through pipe 5, through the reaction tank 25, through pipe 6, through pipe 7 and then into the condenser 27. This water can be defined as the treated water. The portion of the water that does not travel from the cooling tower 33 into the reaction tank 25, but, rather, remains on the path from pipe 4 to pipe 8 and then into the condenser 27, can be defined as the carrier water. At or before the condenser, the carrier water and the treated water can combine to form a combined water flow. This combined water can then travel back to the cooling tower 33 and the process can be repeated until the water is appropriately treated in accordance with the present disclosure. In other embodiments, the treated water travels from the reaction tank 25 into the basin 32 to combine with the recirculated water and the process repeats itself.

In some embodiments, however, a portion of the combined water will travel through pipe 10, pipe 11 and pipe 12 and eventually leave the system 1 as part of a purging process discussed elsewhere throughout this specification.

Additionally, make-up water can be admitted into the system from a make-up water source 30 and travel from pipe 13 through pipes 14 and 15 and into the basin 32. This water then becomes part of the recirculated water that travels throughout the system 1.

Thus, unless otherwise specified throughout the disclosure, references to water include the definition of the recirculated water that continuously travels throughout the system 1, which can include the treated water, carrier water, make-up water and any water otherwise leaving the cooling tower 33 and basin 32.

Reaction Tank

In some embodiments of the present disclosure, an electrochemical cell reaction tank device is present. The reaction tank can be used to treat fouling in water systems. The reaction tank can comprise a tank container comprising at least one water inlet and at least one water outlet; a first metallic fin array comprising at least one sacrificial anode; a second metallic fin array comprising at least one cathode; wherein the first fin array and the second fin array are arranged circumferentially within the tank; and, a device for connecting the at least one sacrificial anode to a power source. The presence of at least one anode and at least one cathode can be generally defined herein as the “electrode assembly.”

In some embodiments, the at least one sacrificial anode comprises copper, zinc, iron, aluminum, silver or an alloy thereof.

In some embodiments, the reaction tank further comprises at least one non-sacrificial anode. The at least one non-sacrificial anode can comprise titanium, platinum or niobium. In other embodiments, the at least one non-sacrificial anode comprises a rod coated with a layer of conductive diamond or mixed metal oxides.

Thus, in some embodiments, the first metallic fin array comprises at least one sacrificial anode and at least one non-sacrificial anode. In other embodiments, the first metallic fin array can comprise at least one non-sacrificial anode without the presence of at least one sacrificial anode.

The at least one cathode in the second metallic fin array can be made of any suitable cathode material generally known in the art, so long as it does not deviate from the scope of the present disclosure.

In some embodiments of the present disclosure, the first metallic fin array comprises at least one sacrificial anode and at least one non-sacrificial anode and the second metallic fin array comprises at least one cathode. In alternative embodiments, the first metallic fin array comprises at least one sacrificial anode without the presence of a non-sacrificial anode and the second metallic fin array comprises at least one cathode. In alternative embodiments, the first metallic fin array comprises at least one non-sacrificial anode without the presence of a sacrificial anode and the second metallic fin array comprises at least one cathode. In other embodiments, the first metallic fin array comprises at least one sacrificial anode and at least one non-sacrificial anode, but the array comprises more non-sacrificial anodes than sacrificial anodes.

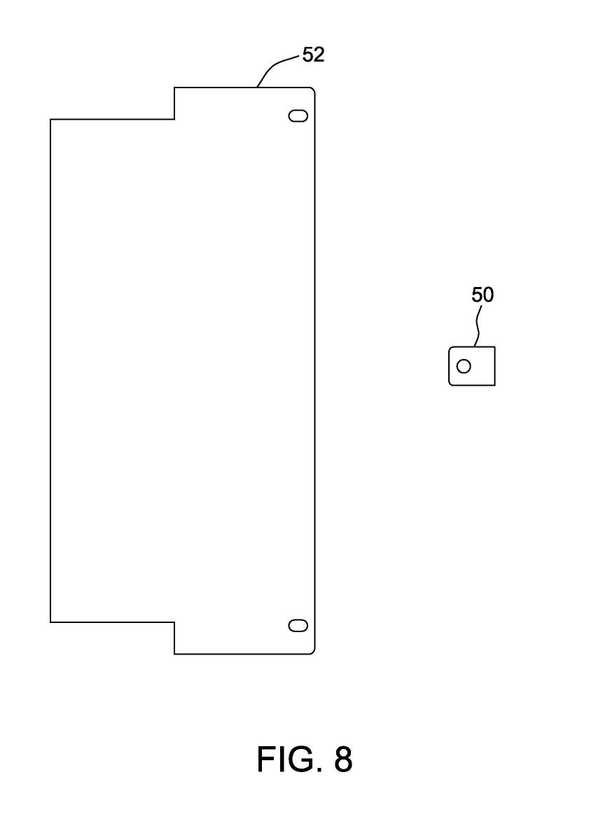

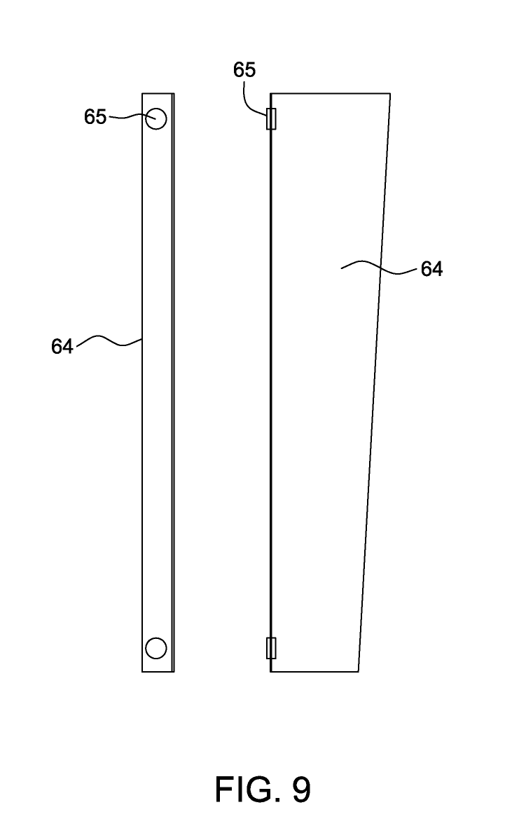

In some embodiments of the present disclosure, the anode and the cathode are in the form of plates. For example, the first metallic fin array can comprise a set of sacrificial anode plates and the second metallic fin array can comprise a set of cathode plates. FIG. 9 depicts an exemplary anode plate 64 in accordance with the present disclosure. Referring now to FIG. 8, an exemplary embodiment of a cathode plate 52 in accordance with the present disclosure is provided. In other embodiments of the present disclosure, the anode and the cathode can be in the form of rods. In some embodiments of the present disclosure, the arrangement of fin arrays is such that at least one anode is spaced between at least two cathodes.

The reaction tank can be made of any suitable material generally known in the art, so long as it does not deviate from the scope of the present disclosure. In some embodiments, the reaction tank can be made of a metal material, a non-metallic material or a combination thereof. When the reaction tank is made of metal or partially of metal, it is preferable to electrically link the interior metal surface to the cathode array to the power supply. This beneficially increases the available surface area of the cathode, which can allow, for example, more scale to be removed at reduced power levels.

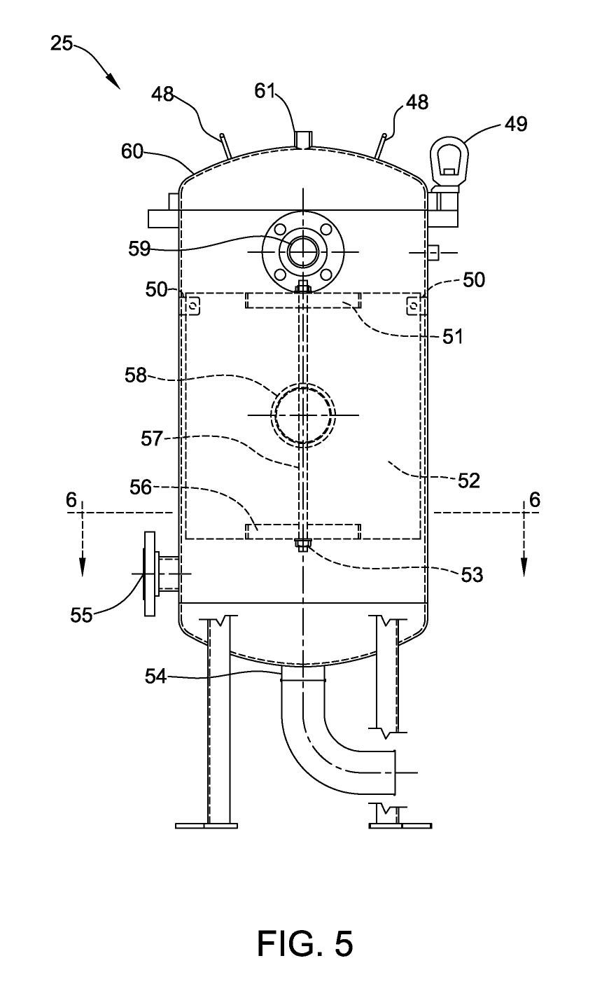

Referring now to FIG. 5, the reaction tank 25 can comprise lid handles 48, a tank lid retention assembly 49, electrode assembly mounting tabs 50, an upper plastic insulator disk 51, a cathode plate 52, an insulator disk retention nut 53, a drain port triclamp assembly 54, a water inlet 55, a lower plastic insulator disk 56, an assembly rod 57, a clear sight glass 58, a water outlet 59, a reaction tank lid 60 and a tank air vent 61.

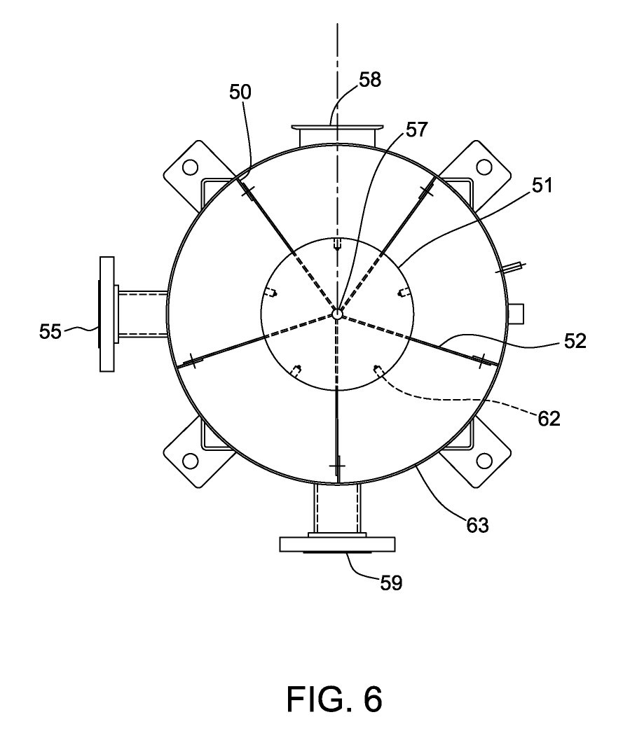

FIG. 6 is a sectional through view of an exemplary embodiment of the reaction tank. FIG. 6 provides an overhead view of what the cathode fin array comprising cathode plates 52 looks like. FIG. 6 also shows threaded mounting holes 62 for mounting anode plate 64 (not shown) onto the insulator disks (e.g., 51) and shows the interior tank surface 63.

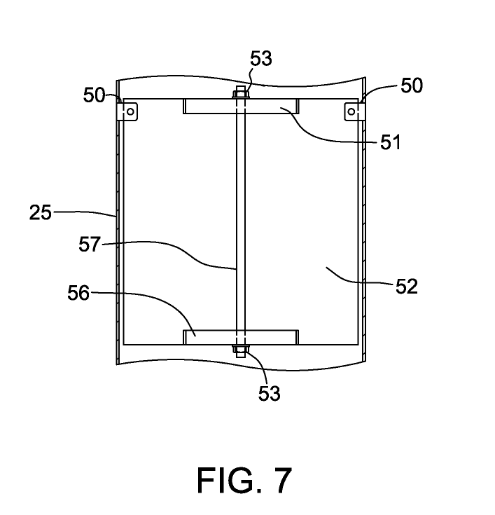

FIG. 7 is a sectional view of an exemplary embodiment of a cathode assembly in accordance with the present disclosure. As can be seen in FIG. 7, the cathode plate 52 can be attached to the reaction tank 25 by the mounting tabs 50 and the upper insulator disk 51 and the lower insulator disk 56 can be affixed to the assembly rod 57 by retention nuts 53.

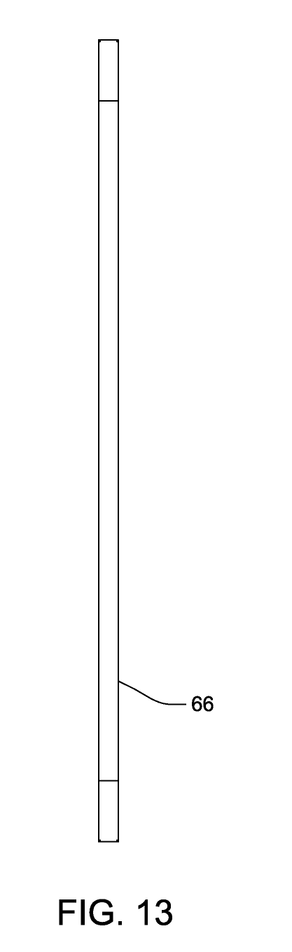

FIG. 8 is a cross-sectional view of an exemplary embodiment of a cathode plate 52 and electrode assembly mounting tab 50 in accordance with the present disclosure. FIG. 9 is a cross-sectional view of an exemplary embodiment of a non-sacrificial anode plate 64 and anode plate bolt 65 in accordance with the present disclosure. FIG. 13 is a cross-sectional view of an exemplary embodiment of a sacrificial anode 66 in accordance with the present disclosure.

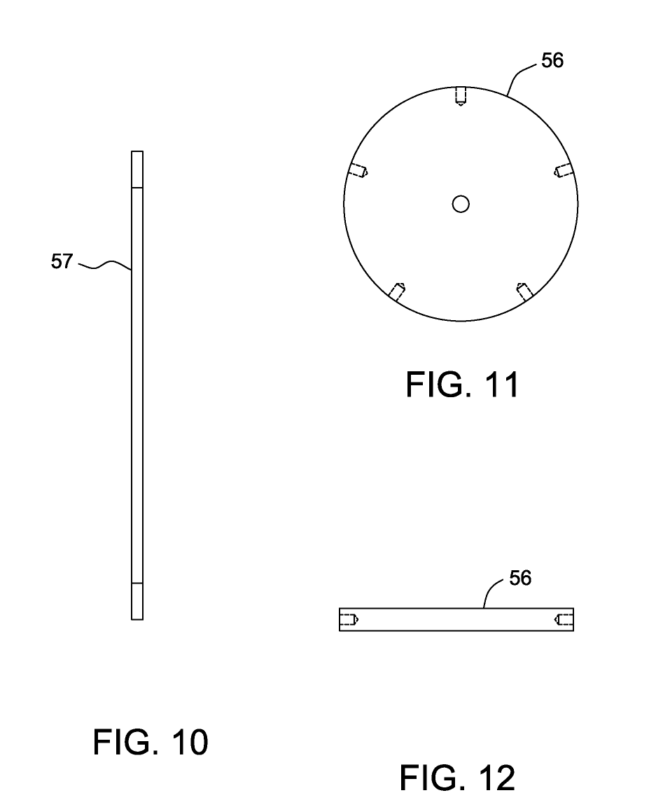

FIG. 10 is a cross-sectional view of an exemplary embodiment of an assembly rod 57 in accordance with the present disclosure.

FIG. 11 is a top view of an exemplary embodiment of an insulator disk 56 in accordance with the present disclosure. FIG. 12 is a cross-sectional view of an exemplary embodiment of an insulator disk 56 in accordance with the present disclosure.

In some embodiments of the present disclosure, a modular electrode assembly with radial electrodes is present where the electrodes are circumferentially arranged and integrated within the reaction tank and make up the electrochemical cell. A modular electrode assembly with radial and circumferentially arranged integral cathode plates can increase the available cathodic surface area and thus can increase the amount of precipitated scale at a lower power usage. Further, a modular electrode assembly with radial electrodes circumferentially arranged within the integral electrochemical tank can be quickly, easily and conveniently removed when enough precipitation has adhered to the cathodes and quickly replaced with an already cleaned module thereby eliminating the need for scrapper mechanisms that are subject to failure and use more energy to operate.

Controller Power Supply

In some embodiments of the present disclosure, a controller power supply is provided. The power supply houses the electrical components that power and manage the water system and process. The power supply comprises an HMI/PLC, which is a programmable logic controller that manages the water treatment process. The power supply also comprises operating software for carrying out instructions to the respective system components as programmed by an operator of the system. The power supply allows the operator to view, change and gather information regarding the treatment system and process. Further, the power supply stores data and reads, reports and translates sensor inputs according to water conditions and programmed instructions.

It should be noted that the term “power supply” as used throughout the present disclosure refers to the power supply unit, which includes the programmable controller. Thus, if an embodiment of the disclosure refers to a component being electrically linked to the power supply, a communication being sent to the power supply, or the power supply commanding a component to do something, it is understood that the power supply incorporates the actions of the controller in such circumstances. Thus, the power supply not only refers to the element of the disclosure that provides power to certain components, but also to the controller therein that directs electrical communications from the controller power supply to the other components.

The power supply can convert high AC power to low DC power. When the reaction tank is supplied with low voltage DC power from the power supply, a high pH environment (i.e., above a pH of 7) is created in the vicinity of the cathodes, which can cause deposition of scale on the cathodes and the interior wall of the metallic tank. Deposition of scale on the cathodes can reduce hardness of the water and propensity of treated water to deposit scale within the water system.

Electrochemical reactions at the non-sacrificial anodes can create a low pH environment (i.e., below a pH of 7) and generate oxidants such as chlorine, hydroxyl radical, ozone, atomic oxygen, super oxides, hydrogen peroxides and other powerful oxides. In particular, halides such as chlorides, bromides and iodides existing naturally in water can be oxidized directly in water producing hypohalous disinfectants, for example, hypochlorite, hypochlorous, hypobromous and hypobromite.

At the sacrificial anode(s), oxidants and metal ions (cations) can be simultaneously produced leading to gradual exhaustion of the sacrificial anode material. The treated water—now with a higher pH in alkaline range above 7, with reduced hardness, reduced propensity for scaling and containing metal ions, hypohalous acids among other oxidants—is returned to water system.

Within the water system, cations and oxidants work synergistically to disinfect water and provide a residual disinfection against proliferation of waterborne microbes. These oxidants disinfect water by inactivating microbial contaminants such as algae, bacteria, mold, viruses and other germs and break up organic molecules such as oils, fats and greases. The scale and corrosion suppression properties of cations of copper, zinc, aluminum, magnesium and iron are thus beneficial to the present disclosure.

Returning now to FIG. 1, some of the water from the cooling tower 33 having entered the reaction tank 25, the electrode assembly as depicted in FIG. 6 and FIG. 7 can cause electrochemical reactions when supplied with DC current from the power supply through electrical line 37. In some embodiments, the power supply can be a constant voltage or constant current type of DC power supply, capable of producing from about 0 to about 180 V, and/or from about 0 A to about 40 A of direct current.

A high pH environment (i.e., a pH of above 7) can be created in the vicinity of the cathode(s), which can cause deposition of scale on the cathode(s) and the interior wall of the reaction tank. The deposition of scale on the cathode(s) can reduce hardness of the water and the propensity of the treated water to deposit scale within the water system.

Continued deposition of scale on the cathode(s) can increase electrical resistance between the cathode(s) and the anode(s). The change in resistance can be automatically detected by the power supply. The change in electrical resistance between the anode and cathode assembly can be influenced by many factors, such as the amount of scale accumulation on the cathode, water temperature, conductivity of water, the age or condition of the anode(s), etc.

The electrical resistance between the cathode and the anode is defined as specific electrode resistance (ERₛₚ), which refers to the electrode resistance due to the absence or presence of adherent scale on the cathode and anode assembly at a specific temperature compensated water conductivity.

The change (increase or decrease) in ERsₚ (ΔERₛₚ) is defined as the difference in the ERₛₚ of a completely clean cathode and one with adherent scale and is exclusive of the electrical resistances contributed by other aforementioned factors.

In some embodiments of the present disclosure, a power output from the power supply is proportional to ΔERₛₚ. In other embodiments, the power supply is configured to increase electrical power output to maintain a pre-programmed user adjustable current set point Aₛₚ. In yet other embodiments, the power supply is configured to increase power output so as to change current by a pre-programmed user adjustable ΔA units above a pre-programmed user adjustable current set point Aₛₚ. In yet other embodiments, the power supply is configured to reduce power output to change current by a pre-programmed user adjustable ΔA units below a pre-programmed user adjustable current set point Aₛₚ.

When the water leaves the cooling tower, in some embodiments of the present disclosure, some of the water from the cooling tower is delivered to the reaction tank. Prior to entering the reaction tank, some of the water from the cooling tower passes through sensors (e.g., chlorine, flow detection, conductivity) that are in electrical communication with the power supply. Based upon the measurements from the sensors, the power supply can supply a given power output to the reaction tank in order to treat the water in the reaction tank in response to the measurements taken by the sensors.

In some embodiments of the present disclosure, the power supply is configured to increase a power output proportional with an increasing conductivity of the cooling tower water. In other embodiments, the power supply is configured to reduce a power output proportional with an increasing conductivity of the cooling tower water. In other embodiments, the power supply is configured to increase a power output proportional with a decreasing conductivity of the cooling tower water.

In other embodiments of the present disclosure, the power supply is configured to increase a power output proportional with a decreasing residual disinfectant concentration in the cooling tower water. In other embodiments, the power supply is configured to provide a constant current to maintain a desired residual disinfectant concentration in the cooling tower water. In yet other embodiments, the power supply is configured to decrease a power output proportional with increasing residual disinfectant concentration in the cooling tower water.

In accordance with one aspect of the present disclosure, it is preferable to operate the water treatment system to obtain cation concentrations in the recirculating cooling water system preferably in the range of from about 0.1 to about 10 ppm, more preferably from about 0.1 to about 1 ppm and most preferably from about 0.1 to about 0.5 ppm.

In accordance with another aspect of the present disclosure, it is preferable to operate the water treatment system to obtain residual disinfectant concentration in the recirculating cooling water system preferably in the range of from about 0.1 to about 5 ppm, more preferably from about 0.1 to about 2 ppm and most preferably from about 0.1 to about 0.5 ppm free chlorine equivalent.

In some embodiments of the present disclosure, the power supply is configured to change a power output proportional to a temperature change of the cooling tower water. In other embodiments, the power supply is configured to change a power output proportional to the pH and/or a change in the pH of the cooling tower water.

In some embodiments of the present disclosure, the power supply is configured to supply a first pre-programmed user adjustable constant current when a conductivity of the cooling tower water is within a first pre-programmed user adjustable conductivity range and a second pre-programmed user adjustable constant current when a conductivity of the cooling tower water is within a second pre-programmed user adjustable conductivity range.

In other embodiments, the power supply is configured to supply a first pre-programmed user adjustable constant current when a conductivity of the cooling tower water is within a first pre-programmed user adjustable conductivity range and a second pre-programmed user adjustable range of current when a conductivity of the cooling tower water is within a second pre-programmed user adjustable conductivity range.

In yet other embodiments, the power supply is configured to supply a first pre-programmed user adjustable constant current when a conductivity of the cooling tower water is within a first pre-programmed user adjustable conductivity range and change a power output proportional to a change in a conductivity when the conductivity of the cooling tower water is within a second pre-programmed user adjustable conductivity range.

In some embodiments, continued deposition of scale on the cathode will increase ΔERₛₚ and can be automatically detected by the power supply. When a pre-programmed user adjustable ΔERₛₚ is reached, the power supply signals an alarm to alert the operator of the power supply to retrieve the scaled-up electrode assembly and replace it with a cleansed one. The modularity of the electrode assembly and the easy access entry in the reaction tank makes it convenient, easy, and fast for the operator to carry out electrode change out. Moreover, the operator can cleanse off accumulated scale at a convenient time and place, in the appropriate manner, to capture and dispose of foulants with minimal harm to the environment.

Electrochemical reactions at the non-sacrificial anode(s) can create a low pH environment (i.e., a pH of below 7) and generate oxidants such as chlorine, hydroxyl radical, ozone, atomic oxygen, super oxides, hydrogen peroxides and other powerful oxides. In particular, halides such as chlorides, bromides and iodides existing naturally in water are oxidized directly in water, producing hypohalous disinfectants, for example hypochlorite, hypochlorous, hypobromous, and hypobromite.

At the sacrificial anode, oxidants and metal ions (cations) are simultaneously produced, which can lead to gradual exhaustion of the sacrificial anode material. In some embodiments, anodic oxidation of the sacrificial anode(s) generates at least Fe(OH)₃, Al(OH)₃ and/or Mg(OH)₂ among other polyvalent and divalent and monovalent metal hydroxides capable of removing both soluble and colloidal silica from water.

The treated water—which now has a pH above 7 in the alkaline range, which promotes limited formation of silicate ions and forming insoluble metal silicates, with reduced hardness, reduced propensity for scaling and containing metal ions, hypohalous acids (among other oxidants)—exits the reaction tank through a pipe 6 and when the outlet valve 18 is open, the treated water is returned to the water system via a pipe 7.

Referring to FIG. 3, water flow is similar to FIG. 1, but the treated water is returned directly to the cooling tower basin 32. In FIG. 3, the treated water —which now has a pH above 7 in the alkaline range, which promotes limited formation of silicate ions and forming insoluble metal silicates, with reduced hardness, reduced propensity for scaling and containing metal ions, hypohalous acids (among other oxidants)—exits the reaction tank 25 through a pipe 45 and when the outlet valve 18 is open, the treated water flows through a pipe 46 and is returned directly to the cooling tower basin 32.

Purging

FIG. 1 provides an exemplary water system 1 admitting a portion of the cooling tower 33 water sequentially through pipe 5 when reaction tank inlet valve 16 is open, and allowing the water to flow through a one-way check valve 21, and then through a disinfectant sensor 22, a flow detecting sensor 23, and a conductivity sensor 24, with the sensors electronically reporting the condition of the water to the power supply 26 as the water passes through each sensor and is admitted into the reaction tank 25, where the water is subjected to electrochemical reactions at the electrode assembly initiated by DC current from the electrically linked power supply 26 and then delivering the treated water from the reaction tank 25 through pipe 6 when outlet valve 18 is open, and finally delivering the treated water to the recirculating cooling water system via pipe 7.

In some embodiments, as the cooling water system 1 continues to circulate, it may be necessary to infrequently purge (aka, “blow down”) water from the cooling water system 1 and to admit fresh make-up water to replenish water lost via purging and evaporation.

In accordance with one aspect of the present disclosure, purging can occur as a result of operating the cooling water system to obtain cooling water conductivity in the range of from about 500-about 10,000 μS/cm, preferably in the range of from about 500-about 8,000 μS/cm, and most preferably in the range of from about 500-5,000 μS/cm.

In some embodiments of the present disclosure, it is preferable to divert a portion of the combined (i.e., treated water and carrier water) water from the condenser 27 to be purged prior to entering the cooling tower 33. Purging warmer water can conserve energy by reducing the load on the cooling tower 33 and can conserve water that would otherwise be evaporated in order to cool the now purged water. Water purging can be based on conductivity, volume, or a combination of both.

In accordance with one aspect of the present disclosure, a portion of the combined water leaving the condenser 27 via pipe 9 can be diverted into purge outlet pipe 10 and flow through a water sensor 28 such as a water meter, a flow meter, a flow switch, a pressure switch, or combinations thereof. Water sensor 28 is electrically linked to the power supply 26 and communicates the status, volume of, and or duration of, water flow, rate of water flow or presence or absence of water or water pressure to the power supply 26 via electrical line 38.

Conductivity Based Purging

In some embodiments of the present disclosure, the operator can pre-program a user adjustable upper conductivity set point (BCP). The BCP can be detected when circulating water passes through the conductivity sensor 24, is reported to the power supply 26, and then the power supply 26 commands the bleed valve 19 to open and release water from the cooling water system 1. The bleed valve 19 can be an automatic valve in some embodiments. Further, the bleed valve 19 can be electrically linked to the power supply via electrical line 39. The process that leads to, and the action of, releasing water from the cooling water system 1 can be defined as the “start of blow down.”

In some embodiments, blow down triggers a low water condition in the cooling tower basin 32 requiring addition of fresh make-up water source 30. A source of suitable fresh make-up water in accordance with the present disclosure includes, but is not limited to, municipal, rain, process or other water so long as it does not deviate from the scope of the present disclosure. The make-up water source 30 can be connected to pipe 13, and when a low water condition is detected in the basin 32 by the water level sensor(s) 31, make-up water valve 20 can be opened to admit water into the cooling tower basin 32. When the water level in the basin 32 is restored to the appropriate level, the make-up water valve 20 can be closed.

The amount of water that constitutes a low water condition will vary depending upon the size of the basin 32 and the amount of water the basin 32 holds. That is, the water basin volume will depend on the size of the cooling tower 33 and the cooling buffering capacity designed in the water system 1. In some embodiments, the cooling tower 33 is a 250 ton cooling tower with a normal operating water condition at 4,000 gallons. In such embodiments, if the level of water is below 4,000 gallons, then a low water condition would be present. If the amount of water is above 4,000 gallons, then a high water condition would be present (i.e., above the normal operating procedure).

The management of the water level in the cooling tower basin 32 can be carried out manually or can be carried out automatically by a water level controller (not shown). Such functions are integrated within the power supply 26 of the present disclosure eliminating the need for manual basin water level management or installation of an additional power supply.

In FIG. 1, the make-up water valve 20, which in some embodiments is automatic, the water flow detecting sensor water meter 29 and the water level sensor 31 are electrically linked and communicate with the power supply 26 via electrical lines 40, 41 and 42, respectively. When the water level sensor 31 detects a low water condition in the basin 32, the power supply 26 commands the make-up water valve 20 to open and admit water into the cooling water basin 32.

A water flow detecting sensor 29 such as a water meter, a flow meter, a flow switch, a pressure switch, or combinations thereof, communicates the status, volume of and or duration of water flow, rate of water flow, or presence or absence of water or water pressure to the power supply 26 as the fresh make-up water 30 enters the basin 32. When the water level sensor 31 detects that an appropriate water level has been restored to the basin 32, the power supply 26 commands the make-up water valve 20 to close and stop admitting water to the basin 32.

The initiation of, and termination of, addition of fresh make-up water 30 into the basin 32 can be defined as the “make-up process.”

In some embodiments, the make-up process dilutes and reduces the conductivity of the circulating water. In some embodiments, the operator of the controller power supply 26 can pre-program a user adjustable lower conductivity set point (LCP). In those embodiments, the LCP is detected when some of the circulating water from the cooling tower 33 passes through the conductivity sensor 24 and is reported to the power supply 26, the power supply 26 commands the bleed valve 19 to close, which in turn stops the release of water from the cooling water system 1 and can be defined as the “termination of blow down.”

In accordance with one aspect of the present disclosure, the difference between BCP and LCP is defined as the water treatment hysteresis (HWT) (i.e., BCP−LCP=HWT). In some embodiments, the HWT can be user programmable by the operator of the power supply 26 within a preferable water conductivity range of the cooling water system. In other embodiments, the HWT can be a percentage of BCP, a percentage of LCP, or, a value such that BCPLCP.

Collectively, the start of blown, followed by the make-up process and ending with termination of blown down can be defined as the “blow down cycle” and the sequential operation of the water system involving start of blow down followed by the make-up process and ending with termination of blow down can be defined as the “management of cooling water conductivity.”

Volume Based Purging

Alternatively, in some embodiments, when the water level sensor 31 detects low water conditions in the basin 32, the power supply 26 commands the make-up water valve 20 to open and admit fresh make-up water 30 into the basin 32 and then close. The specific volume of make-up water 30 admitted can be calculated by the power supply 26 and defined as MUₛₚ. The power supply 26 then commands the blow down valve 19 to open and release a pre-programmed user adjustable volume defined as BDₛₚ of the circulating combined water and then close.

In accordance with one aspect of the present disclosure, the pre-programmed user adjustable value of BDₛₚ is a percentage of the specific volume of fresh make-up water MUₛₚ such that 0≦BDₛₚ≦MUₛₚ. In other embodiments, the ratio of the volume of purged water from the cooling system to the volume of fresh make-up water into the cooling system is greater than zero but less than or equal to one.

In some embodiments of the present disclosure, the purging of water from the cooling system is based on conductivity. In other embodiments, the purging of water from the cooling system is based on volume. In yet other embodiments of the present disclosure, the purging of water from the cooling system is based on a combination of conductivity and volume.

Types of Fouling

Water fouling due to corrosion, scale, microbial and particulate build up is complex and interrelated. One mode of fouling promotes and exacerbates the others. For example, when suspended particles settle in low flow areas, under deposit corrosion of metallic surfaces can occur. Moreover, corrosion of metal in turn can increase the amount of suspended solids in water, and thus provide nutrients and shelter to waterborne microbes. Without proper control of all modes of fouling, no device or system will succeed in effectively protecting the water conducting circuits from aforementioned fouling problems.

As defined herein, the term “treating” with respect to fouling in water includes not only removing fouling from water, improving fouling in water (i.e., improving the water quality), etc., but also includes preventing and/or preempting fouling in water systems. Thus, the methods, systems and devices of the present disclosure not only can improve water that has been fouled, but can also prevent fouling in water that is considered “clean” or without fouling in instances where fouling would otherwise occur.

Scale Fouling and Control

Scale deposits can form when dissolved minerals precipitate and grow on heat transfer surfaces or in bulk water. Precipitation can occur when the solubility of a dissolved mineral is exceeded either in the bulk water or on heat transfer surfaces. The most common scale-forming salts that precipitate exhibit inverse solubility with increasing temperature. Although they may be completely soluble in the lower-temperature bulk water, minerals such as calcium carbonate, calcium phosphate, and magnesium silicate supersaturate in higher-temperature water adjacent to and or in contact with heat transfer surfaces and precipitate on those surfaces.

Scaling, however, is not always related to temperature. For example, calcium carbonate and calcium sulfate scaling can occur on unheated surfaces when their solubility is exceeded in the bulk water. Once formed, scale deposits can initiate additional nucleation, and crystal growth proceeds at an accelerated rate.

In accordance with the present disclosure, as the cooling tower water is continuously treated, scale forming salts are precipitated and captured on the cathode walls of the electrochemical cell in the reaction tank. Silica—another form of scale—can be removed by controlled intentional precipitation with and adsorption to polyvalent metal hydroxide. Cations introduced in the cooling water interfere with the arrival and incorporation of scale forming ions on particles. These surface active cations adsorb to the growing crystal lattice thereby getting in the way of dissolved mineral salts attempting to precipitate and thus protecting heat transfer surfaces in contact with the cooling water.

In bulk water far from heat transfer surfaces, alternative scale nucleation sites are provided in the form of free floating scale particles dislodged from the cathode electrodes by water flow, or through the introduction of aforementioned polyvalent metal hydroxides or dislocation of previously adhered scale. This way a “limited” bulk scale precipitation can occur away from the heat transfer surfaces and their size and quantity being inhibited by the very presence of cations.

Microbial Fouling and Control

Microbial growth on wetted surfaces can lead to the formation of biofilm adversely affecting equipment performance while increasing operations costs. Two types of microorganisms can be present in cooling water: free-floating (planktonic) populations found in bulk water and attached (sessile) populations that colonize heat transfer surfaces.

Sessile population is responsible for most microbial fouling. Biofilm adheres firmly on surfaces and consumes oxidizers before they reach and destroy microorganisms. Control of sessile microorganisms therefore can require higher chemical dosages than required to control planktonic organisms. Biofilm polymers are sticky and aid in the attachment of new cells to the colonized surface as well as the accumulation of nonliving debris from the bulk water.

Biofilm on heat exchange surfaces can act as an insulating barrier. Heat exchanger performance can begin to deteriorate as soon as biofilm thickness exceeds that of the laminar flow region. In terms of heat transfer efficiency, a biofilm is the equivalent of a layer of stagnant water along the heat exchange surface. Like water, biofilm is about 25 to about 600 times more resistant to heat transfer than many metals. A thin layer of biofilm can reduce heat transfer by an amount equal to a large increase in exchanger tube wall thickness. For example, a 1 mm biofilm layer on a carbon steel exchanger wall is equivalent to an 80 mm increase in tube wall thickness. Biofilm can promote corrosion of fouled metal surfaces by preventing corrosion inhibitors from reacting metal surfaces, using up metal as a source of food for metabolism and generating corrosive by-products that directly attack the metallic surface.

In some embodiments, water flowing through the electrochemical cell reaction tank is subjected to extreme high (i.e., above a pH of 7) and low pH (i.e., below a pH of 7) at the cathode and anode regions, respectively. This action can deactivate waterborne microbes by distorting cellular pH and denaturing proteins. At the non-sacrificial anode(s), powerful oxidants and disinfectants are generated directly in water, and in combination with cations produced at the sacrificial anode(s) provide a multi-pronged residual protection against waterborne microbes. In particular, aluminum/copper complex Cu[Al(OH—)₄]+ gel floc produced at the sacrificial anode and introduced into the water system, coats heat transfer surfaces and greatly reducing occurrence of biofilm and sessile microbes. Cu[Al(OH—)₄]+ gel floc can also entrap and immobilize free floating planktonic microbes.

Corrosion Fouling and Control

Corrosion can cause two basic problems. The first problem can be the failure of equipment with the resultant cost of replacement and plant downtime. The second can be decreased plant efficiency due to loss of heat transfer—the result of heat exchanger fouling caused by the accumulation of corrosion products. Localized corrosion occurs when the anodic sites remain stationary, and is a more serious industrial problem. Forms of localized corrosion include pitting, selective leaching (e.g., dezincification), galvanic corrosion, crevice or under-deposit corrosion, inter-granular corrosion, stress corrosion cracking, and microbiologically influenced corrosion. Pitting occurs when anodic and cathodic sites become stationary due to large differences in surface conditions. It is generally promoted by low-velocity or stagnant conditions. Once a pit is formed, the solution inside it is isolated from the bulk environment and becomes increasingly corrosive with time. The high corrosion rate in the pit produces an excess of positively charged metal cations, which attract chloride anions. In addition, hydrolysis produces H+ ions. The increase in acidity and concentration within the pit promotes even higher corrosion rates, and the process can become self-sustaining.

The presence of a biofilm can contribute to corrosion (microbial induced corrosion) in three ways: physical deposition, production of corrosive by-products, and depolarization of the corrosion cell caused by chemical reactions. Biofilm can cause accelerated localized corrosion by creating differential aeration cells. This same phenomenon occurs with a biofilm. The non-uniform nature of biofilm formation can create an inherent differential, which is enhanced by the oxygen consumption of organisms in the biofilm. Many of the by-products of microbial metabolism, including organic acids and hydrogen sulfide, are corrosive. These materials can concentrate in the biofilm, causing accelerated metal attack.

In some embodiments of the present disclosure, microbial-induced corrosion is arrested when heat transfer surfaces exposed to the treated water are coated with Cu[Al(OH—)₄]+ gel floc reducing the occurrence of biofilm and sessile microbes. In other embodiments, the water system is operated in the alkaline pH region in order to control corrosion. In addition, without chemical injection, metallic surface corrosion due to acid use can be eliminated.

Particulate Fouling and Control

Particulate fouling can occur when particulates suspended in recirculating water form deposits on a heat transfer surface. Generally, heat exchangers have relatively thin and thermally conductive walls—both characteristics selected primarily for heat transfer efficiency. The thin-walled enhance tubes are most vulnerable to puncture failure due to corrosion attacks. The enhancements provide ideal pockets for biofilm establishment and settlement of suspended solids creating perfect niches for microbial induced corrosion and under deposit corrosion. Fouling mechanisms in water circuits such as cooling water are dominated by particle-particle interactions that lead to the formation of agglomerates. One significant factor affecting the settling rate is the size of the particle. Because of this, the control of fouling by preventing agglomeration and settlement is one of the most important aspects of deposition control.

Suspended particles such as clay, silt, and iron oxides can enter a system with make-up water. Others can be introduced as airborne contamination, process leaks, corrosion particles and precipitated scale. Insoluble aluminum and iron hydroxides can also enter a system from make-up water pretreatment operations. The accumulation of fouling materials leads to choking of condenser tubes, degradation of heat transfer and reduced performance of heat exchangers. The susceptibility to corrosion necessitates frequent cleaning of heat exchangers causing downtime and lost productivity. Manual cleaning also presents serious risks, because thin-walled tubes can easily be punctured by hard scrapers or etched by corrosive acid/caustic chemicals. In many cases, such damage is not evident until the heat exchanger is brought back online.

The present disclosure can improve filtration efficiency, because Cu[Al(OH—)₄]+ gel flocs entrap smaller suspended solids such as “limited” bulk precipitated scale making them larger and easier for removal by a filtration module. Therefore smaller filter skids with improved performance can remove more suspended solids, more efficiently and at lower filtration costs.

When previously adherent precipitated salts such as silicates enter the electrochemical cell reaction tank, they are subject to high pH (i.e., a pH of above 7) in the vicinity of the cathode and are precipitated on the cathode wall and removed from circulating cooling water.

In other embodiments, particulate control is also achieved by management of the cooling water in accordance with the present disclosure ensuring proper and reliable operation of the blow down cycle of water the cooling system.

In some embodiments of the present disclosure, the system and/or process preempts, prevents, reverses, removes, treats, and/or improves fouling in water due to scale formation, microbial formation, corrosion, particulate formation, and combinations thereof.

Water Management

The present disclosure integrates electrochemical scale precipitation and anodic dissolution of a metal anode, generation of residual disinfectants, corrosion, scale, microbial and particulate inhibiting cations, all within one electrochemical cell reaction tank.

Proper water management is important to obtaining optimal benefits of the present disclosure. In some embodiments of the present disclosure, bleed valve 19 and make-up water valve 20 are equipped with auxiliary position sensors (not shown) so as to report when the valves are actually opened or closed, as well as how long they stay open and when they are closed. These important features are integrated features of the present disclosure that can help in detecting and quickly resolving malfunctions. For instance, when bleed valve 19 is detected to be open for too long, or closed when needed to be open, and vice versa, then the power supply 26 can signal an alarm to alert the operator to such a malfunction. Likewise, if the power supply 26 detects the automatic bleed valve 19 is functioning correctly yet the conductivity is increasing as opposed to decreasing relative to HWT, then a malfunction of the make-up water valve 20 may have occurred, and then the power supply 26 can signal a different alarm to alert the operator to such a potential malfunction.

Cation Management

In some embodiments of the present disclosure, the power supply can inject cations into the water system to maintain a preferable cation concentration range. The system of the present disclosure is surprisingly and unexpectedly able to achieve such a cation concentration range without the need for costly, cumbersome and often maintenance-intensive inline and or manual testing apparatuses. By monitoring how much water has been discharged and or how long the bleed valve stays open, and or the volumetric blow down, a precise amount of current (x) for a precise amount of time (y) can be impressed on the sacrificial anode(s) to release a specific amount of cations into the water system to replenish cations lost via blow down.

As defined herein, the action of supplying DC power from the power supply to the sacrificial anode(s), the non-sacrificial anode(s), or combinations thereof, in the reaction tank to release an amount of cations and maintain cation concentration in the recirculating cooling water system is referred to as “metered ionization.” In some embodiments of the present disclosure, metered ionization is conducted to maintain a cation concentration range in the water system of from about 0.1 to about 10 ppm, more preferably from about 0.1 to about 1 ppm, and most preferably from about 0.1 to about 0.5 ppm. That is, the amount of cations released into the water system is correlated to the amount of water discharged from the water system so as to maintain cation concentrations in the circulating cooling water system within these ranges.

In some embodiments, the amount of cations being introduced into the water is correlated with the volume of water lost during blow down.

In some embodiments, the cations are released into the reaction tank water that is to be treated. In some embodiments, the power supply sends current to the reaction tank and then the sacrificial anode releases cations into the water in the reaction tank. In some embodiments, the cations are released into the reaction tank water in an amount needed to maintain a cation concentration in the combined water of from about 0.1 ppm to about 10 ppm.

In some embodiments of the present disclosure, the amount of cations released into the water system correlates to the duration of how long the bleed valve stays open.

In other embodiments of the present disclosure, the amount of cations released into the water system correlates to water treatment hysteresis (HWT).

In other embodiments, the amount of cations released into the water system correlates to water treatment hysteresis and is user programmable within the preferable water conductivity range of the cooling water system.

In other embodiments, the amount of cations released into the water system correlates to a user programmable water system conductivity in the range of from about 500 to about 10,000 μS/cm, preferably from about 500 to about 8,000 μS/cm, more preferably from about 500 to about 5,000 μS/cm.

In other embodiments, the amount of cations released into the water system correlates to a pre-programmed user adjustable upper conductivity set point (BCP). In other embodiments, the amount of cations released into the water system correlates to a pre-programmed user adjustable lower conductivity set point (LCP). In yet other embodiments, the amount of cations released into the water system correlates to a pre-programmed HWT, which can be a percentage of BCP, a percentage of LCP, or a value such that BCPLCP.

In other embodiments, the amount of cations released into the water system correlates to the amount of current (x) impressed for time (y) on the anode(s) to release an amount of cations into the water system to replenish cations lost via blow down. In some embodiments, the amount of current impressed/supplied on the anode(s) is from about 0 to about 40 A, preferably from about 0 to about 10 A, and more preferably from about 0 to about 5 A. In some embodiments, the amount of time the current is impressed/supplied to the anode(s) is from about 0 to about 24 hours, preferably about 2 hours.

In other embodiments, the metered ionization is carried out at the start of the blow down cycle, preferably during the blow down cycle, and more preferably after the blow down cycle.

In other embodiments, the metered ionization is carried out at the start of the volume based purging, preferably during the volume based purging, and more preferably at the end of the volume based purging.

In other embodiments, the metered ionization is carried out at the start of the conductivity based purging, preferably during the conductivity based purging, and more preferably at the end of the conductivity based purging.

In some embodiments, the non-sacrificial anode(s) and the sacrificial anode(s) are powered simultaneously. In other embodiments, the non-sacrificial anode(s) and the sacrificial anode(s) are powered alternating between one and the other.

Particulate Filter

In some embodiments, a particulate filter is present and can improve water clarity. Referring to FIG. 2, the water flow is similar to FIG. 1 but a particulate filter 44 is located downstream of the reaction tank 25 such that treated water exiting outlet valve 18 flows through pipe 7 and enters the particulate filter 44. The particulate filter 44 traps suspended particles and thus removes them from the treated water. The filtered treated water is then returned to the cooling water system. Particulate filter 44 can be electrically linked via electrical line 43 to the power supply 26 in order to monitor and communicate its operational conditions such as, for example, flow rate, pressure or differential pressure, and filter status. When a pre-programmed user adjustable filter criteria is met, the power supply can signal an alarm to alert the operator of the water system.

Referring to FIG. 4, the water flow is similar to FIG. 3, but a particulate filter 44 is located downstream of the reaction tank 25 such that the treated water exiting the outlet valve 18 flows through pipe 45 and enters the particulate filter 44 via pipe 46. Particulate filter 44 traps suspended particles and thus removes them from the treated water. The filtered treated water then flows through pipe 47 and is returned directly to the cooling tower basin 32. Particulate filter 44 can be electrically linked via electrical line 43 to the power supply in order to monitor and communicate its operational conditions such as, for example, flow rate, pressure or differential pressure, and filer status. When a pre-programmed user adjustable filter criteria is met, the power supply can signal an alarm to alert the operator of the water system.

Cooling Tower

The cooling tower of the present disclosure can be any cooling tower generally known in the art so long as it does not deviate from the scope of the present disclosure.

Basin

The basin of the present disclosure can be any basin generally known in the art so long as it does not deviate from the scope of the present disclosure. In some embodiments of the present disclosure, the basin comprises at least one water level sensor. In other embodiments, the basin includes multiple water level sensors.

The water level sensors detect the amount of water in the basin. In some embodiments, the water level sensors in the basin can be connected to the power supply by an electrical line. The management of the water level in the basin can be done manually or automatically by a water level controller (not shown in the figures). The management of the water level in the basin can be done through the electrical connection of the basin and the power supply.

Sensors

The sensors of the present disclosure can be any sensor generally known in the art so long as it does not deviate from the scope of the present disclosure. The sensors can function to measure water parameters such as, for example, temperature, total dissolved solids (TDS), chlorine residual, metal ion concentrations, pH, alkalinity, salinity, and oxidation reduction. The sensors can also function to measure water volume, rate of water flow, detect presence or absence of water, measure pressure of water and/or indicate whether or not water is flowing.

In some embodiments of the present disclosure, a disinfectant sensor can be used. Some of the water from the cooling tower can flow through the disinfectant sensor. The disinfectant sensor can be any sensor capable of detecting, for example, free chlorine, ozone, hydrogen peroxide, chlorine dioxide, free bromine, total bromine, Oxidation Reduction Potential (ORP) or a combination thereof in water. The disinfectant sensor can provide a means to measure the capacity of the water to prevent microbial build-up. Some of the water from the cooling tower can flow through the disinfectant sensor prior to the water entering the reaction tank. In some embodiments of the present disclosure, the disinfectant sensor is connected to the power supply by an electrical line and is in communication with the power supply. In some embodiments of the present disclosure, the disinfectant sensor is a chlorine sensor.

In some embodiments of the present disclosure, a flow detecting sensor can be used. The flow detecting sensor can be a flow switch, a flow meter, a pressure switch, or any combination thereof capable of detecting water movement, as well as the presence or absence of water. The flow detecting sensor can play an important role of proving water flow for safe and convenient operation of the present disclosure. If the sensor detects no flow, downstream processes may be stopped or suspended and an alarm initiated by the power supply to alert the operator. Some of the water from the cooling tower can flow through the flow detecting sensor prior to the water entering the reaction tank. In some embodiments of the present disclosure, the flow detecting sensor is connected to the power supply by an electrical line and is in communication with the power supply.

In some embodiments of the present disclosure, a conductivity sensor can be used. The conductivity sensor can be capable of detecting the level of dissolved and suspended solids in the circulation water prior to entering the reaction tank. The conductivity level correlates to the cleanliness of cooling water and can be used to manage the operation of other components in accordance with several aspects of the present disclosure. Some of the water from the cooling tower can flow through the conductivity sensor prior to the water entering the reaction tank. In some embodiments of the present disclosure, the conductivity sensor is connected to the power supply by an electrical line and is in communication with the power supply.

In some embodiments of the present disclosure, a disinfectant sensor, a flow detecting sensor and a conductivity sensor are present. In other embodiments, some of the water from the cooling tower passes through the disinfectant sensor, the flow detecting sensor and the conductivity sensor prior to entering the reaction tank.

In some embodiments of the present disclosure, a water flow detecting sensor water meter is present. The water meter sensor can be electrically connected to the power supply by an electrical line, and can communicate the status, volume of and or duration of water flow, rate of water flow or presence or absence of water or water pressure to the power supply via the electrical line. In some embodiments of the present disclosure, the water meter sensor is present intermediate the condenser and the cooling tower. In other embodiments, the water meter sensor measures the water as it travels through a pipe and then the water passes through the water meter sensor and into a bleed valve before exiting the water system via the piping system.

In some embodiments, a second water flow detecting sensor water meter can be used (see, e.g., FIG. 1, reference numeral 29). This second water meter sensor can be a water meter, a flow meter, a flow switch, a pressure switch, or combinations thereof, that communicates the status, volume of and or duration of water flow, rate of water flow or presence or absence of water or water pressure to the power supply as make-up water enters the basin. In some embodiments, the second water meter sensor is present intermediate the make-up water source and the basin. In other embodiments, the second water meter sensor measures the water is it flows from the make-up water source and then the water passes through the second water meter sensor to the make-up water valve and eventually into the basin. It should be understood, however, that the second water meter sensor can be present even if no other water meter sensors are present in a particular embodiment.

Valves

The valves of the present disclosure can be any valve generally known in the art so long as it does not deviate from the scope of the present disclosure. In some embodiments, a reaction tank inlet valve is used to admit water into the reaction tank to be treated and a reaction tank outlet valve is used to admit water out of the reaction tank. In some embodiments, both the reaction tank inlet valve and the reaction tank outlet valve may automatically open and/or close to deliver the water. In some embodiments, a drain valve may be used to drain water from the reaction tank.

For example, in some embodiments of the present disclosure, the water treatment system can include a reaction tank inlet valve in hydraulic communication with a water inlet pipe. When the inlet valve is open, a portion of the water flows through the inlet valve, and through a check valve which allows water to flow only in the direction of the reaction tank. The check valve allows for convenient operation of the present disclosure by preventing water from flowing in the opposite direction of the reaction tank in case of pressure loss downstream. The inlet valve allows for convenient operation of the present disclosure by providing a means to temporarily prevent water flow when needed.

In other embodiments of the present disclosure, a make-up water valve is used to admit water from a make-up water source into the water system. In some embodiments, the make-up water valve can operate automatically to admit the water into the system.

In some embodiments, a water system bleed valve may be used to release water from the water system. In some embodiments, the bleed valve can operate automatically to release water from the system.

In other embodiments of the present disclosure, isolation valves may be used for hydraulically segregating a particular component from the water system.

In some embodiments of the present disclosure, the system comprises a reaction tank water inlet valve for directing water into the reaction tank; a check valve for directing water into the reaction tank; a drain valve for emptying water from the reaction tank; a reaction tank water outlet valve for directing water out of the reaction tank; a water system bleed valve for releasing water from the water system; and, a make-up water valve for admitting water into the water system.

Piping System

The piping system of the present disclosure can be any piping system generally known in the art so long as it does not deviate from the scope of the present disclosure. The piping system includes at least one pipe and is used for a variety of transportation methods of the water throughout the water system. As shown in FIGS. 1-4, pipes can be used in the present disclosure to deliver the water to be treated to the reaction tank, to deliver the treated water from the reaction tank to either the condenser or the basin, to hydraulically connect valves, flow meters, sensors, and other water parameter measuring instruments to each other and to the reaction tank, and, for draining water from the reaction tank. The pipes may also be used to admit make-up water to the system and to purge water from the system.

Thus, in some embodiments, the piping system is part of a delivery system that is operable to deliver some of the water from the basin to the electrochemical cell reaction tank to produce a flow of treated water, and delivering the treated water toward the condenser, the delivery system being further operable to deliver the remaining water from the basin toward the condenser for admixture with the treated water to define a combined flow of water.

Electrical Wiring

The electrical wiring of the present disclosure can be any electrical wiring generally known in the art so long as it does not deviate from the scope of the present disclosure. As shown in FIGS. 1-4, the electrical wiring can be used in the present disclosure to connect various components to the power supply. For example, electrical wiring may be used for electrically connecting water parameter detecting sensors to the power supply, as well as electrically connecting the anode and/or cathode in the reaction tank to the power supply, or, for supplying AC power from a main switch (not shown) to the power supply.

When introducing elements of the present disclosure or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

In view of the above, it will be seen that the several advantages of the disclosure are achieved and other advantageous results attained. As various changes could be made in the above processes and composites without departing from the scope of the disclosure, it is intended that all matter contained in the above description and shown in the accompanying drawings shall be interpreted as illustrative and not in a limiting sense.

1. A process for treating fouling in water systems, the process comprising:
delivering water to a cooling tower for cooling the water;
delivering some of the water from the cooling tower to an electrochemical cell reaction tank, to define a flow of treated water, the reaction tank comprising an anode and at least two cathodes, wherein the anode is positioned between the at least two cathodes;
supplying current to the reaction tank from a controller power supply such that scale deposits form on a surface of the at least two cathodes;
delivering the treated water to a basin;
delivering the remaining water from the cooling tower toward a condenser to define a flow of carrier water;
delivering the carrier water from the condenser into the cooling tower and toward the basin; and
combining the flow of treated water with the flow of carrier water in the basin.

2. The process of claim 1, further comprising passing the water through a disinfectant sensor, a flow detecting sensor and a conductivity sensor before the water enters the reaction tank.

3. The process of claim 1, further comprising passing the treated water through a particulate filter prior to the water entering the basin.

4. The process of claim 1, further comprising purging the carrier water intermediate the condenser and the cooling tower.

5. The process of claim 4, wherein the purging is based on conductivity, water volume, or a combination thereof.

6. The process of claim 1, further comprising admitting make-up water into the basin from a make-up water source.

7. The process of claim 1, further comprising releasing cations into the reaction tank water.

8. The process of claim 7, wherein the cations are released into the reaction tank water in an amount needed to maintain a cation concentration in the combined water of from about 0.1 ppm to about 10 ppm.

9. A system for treating fouling in water, the system comprising:
water;
a cooling tower for cooling the water;
a basin for collecting the cooled water;
an electrochemical cell reaction tank, the reaction tank comprising an anode and at least two cathodes, wherein the anode is positioned between the at least two cathodes;
a power source connected to the anode and the at least two cathodes, wherein the power source is configure to supply current to the electrochemical cell reaction tank such that scale deposits form on a surface of the at least two cathodes;
a condenser for heating the water; and,
a delivery system operable to deliver some of the water from the basin to the electrochemical cell reaction tank to produce a flow of treated water, and delivering the treated water to the basin, the delivery system being further operable to deliver the remaining water from the basin through the condenser, into the cooling tower, and then back into the basin for admixture with the treated water to define a combined flow of water.

10. The system of claim 9, further comprising a disinfectant sensor for detecting chlorine, ozone, hydrogen peroxide, chlorine dioxide, bromine, oxidation reduction potential, or a combination thereof in the water; a flow detecting sensor for detecting water movement; and, a conductivity sensor for detecting the level of solids in the water.

11. The system of claim 10, wherein the system is arranged such that water passes through the disinfectant sensor, then through the flow detecting sensor, then through the conductivity sensor and then into the reaction tank.

12. The system of claim 9, further comprising at least one water level sensor in the basin for detecting the amount of water in the basin.

13. The system of claim 9, wherein the system comprises a reaction tank water inlet valve for directing water into the reaction tank; a check valve for directing water into the reaction tank; a drain valve for emptying water from the reaction tank; a reaction tank water outlet valve for directing water out of the reaction tank; a water system bleed valve for releasing water from the water system; and, a make-up water valve for admitting water into the water system.

14. The system of claim 9, further comprising a make-up water source.

15. The system of claim 9, wherein the power source releases cations into the reaction tank water.

16. The system of claim 15, wherein the cations are released into the reaction tank water in an amount needed to maintain a cation concentration in the combined water of from about 0.1 ppm to about 10 ppm.

17. The system of claim 9, further comprising a particulate filter for trapping suspended particles from the treated water.

18. An electrochemical reaction tank device for treating fouling in water systems, the device comprising:
a tank container comprising at least one water inlet and at least one water outlet;
a first metallic fin array comprising a non-sacrificial anode;
a second metallic fin array comprising at least two cathodes, wherein the non-sacrificial anode is positioned between the at least two cathodes;
wherein the first fin array and the second fin array are arranged circumferentially within the tank such that the non-sacrificial anode and the at least two cathodes are oriented substantially radially relative to a central axis extending vertically through the tank container; and,
a device for connecting the non-sacrificial anode to a power source.

19. The reaction tank device of claim 18, wherein the at least one non-sacrificial anode comprises titanium, platinum, niobium, or combinations thereof.

20. The reaction tank device of claim 19, wherein the at least one non-sacrificial anode is coated with a layer of conductive diamond, mixed metal oxides, or a combination thereof.
